(19) United States
(12) Patent Application Publication
(10) Pub. No.: US 2003/0010457 A1
(43) Pub. Date: Jan. 16, 2003

(54) DEVICE FOR ADJUSTING ORIENTATION OF A VENETIAN BLIND

(76) Inventor: Yu-Ting Kao, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/901,718

(22) Filed: Jul. 11, 2001

(51) Int. Cl. E06B 9/38

(52) U.S. Cl. 160/177 R

(57) ABSTRACT

A zero-adjuster for lateral blind leaves includes a transmitting gear engaging a worm having an end engage portion inserted in a shaft hole of an actuating wheel. When the ropes on the actuating wheel are pulled downward, the actuating wheel with the worm activated to rotate the transmitting gear and the square shaft biasly to let the ropes on the square shaft adjust the leaves angles. Plural position plates arranged in a hexagon shape, with a gap formed to let each position plate have proper elasticity and a spring provided between a pair of the position plates to maintain a definite elasticity, define the hollow portion of the worm. When the leaves angles are adjusted to the maximum and the transmitting gear and the worm cannot rotate and if the ropes are continually pulled, the position plates deform inward and the actuating wheel rotates idle, preventing the worm from damaged.

### BACKGROUND OF THE INVENTION

This invention relates to a zero-adjuster for lateral leaves of a blind, particularly to one possible to prevent a worm of the zero-adjuster from producing disorder and damaged.

Blinds can control light to come into a room by adjusting the angles of its leaves, so blinds have been widely used in houses and various locations. A commonly conventional zero-adjuster for angles of lateral leaves of a blind shown in FIGS. 7 and 8 has a housing 1 provided inside with a transmission gear 2, a worm 3 and an actuating wheel 4 with a square shaft 5 combined together. The housing 1 formed by combining two half members together is to be fixed on a window frame above the top of a blind. The transmission gear 2 engaged with the worm rod 3 has a square hole 21 in the center for the square shaft 5 of the actuating wheel 4 to engage therein. The worm 3 has an engage portion 31 formed at one end formed into two position plate members 311, 312 spaced apart by a preset space so as to have a function of deforming elastically, and besides, the two position plate members 311, 312 respectively have an engage lug 313, 314 formed at their ends to be inserted smoothly in the square hole 41 of the actuating wheel 4 after the engage portion 31 of the worm 3 extends out of the housing 1, combining the worm rod 3 and the actuating wheel 4 together. The actuating wheel 4 has an annular groove on its outer circumferential edge for a rope 42 to wind thereon. Thus, when the rope 42 is pulled downward, the actuating wheel 4 together with the worm 3 will be rotated and synchronously drive the transmission gear 2 and the square shaft 5 to rotate biasly. As adjusting ropes 51 are fixedly connected to the square shaft 5 and to the leaves 6 of a blind, the biased rotating of the square shaft 5 will make the leaves 6 of a blind move biasly to adjust the angles of the leaves 6.

In accordance with the structure of the conventional zero-adjuster for angles of lateral leaves of a blind mentioned above, the engage portion of the worm is fixedly engaged in the square shaft hole of the actuating wheel, therefore, when a user pulls the rope downward quickly to adjust the angles of the leaves, the actuating wheel together with the worm rod will rotate and at the same time drive the transmission gear and the square shaft to rotate and also activate the leaves to adjust their angles.

However, when the angles of the leaves are adjusted to an utmost limit and the transmission gear cannot rotate any more, a deadlocked condition between the worm and the worm gear will occur. In this case, if the rope is continually pulled downward quickly, the wrench force of the actuating wheel becomes larger than the engaging force between the square shaft hole of the actuating wheel and the engage portion of the worm, as a result, the deadlocked engage portion of the worm is liable to split. Furthermore, when the rope is pulled to move the leaves of the blind to the maximum point and then released, a counter bouncing phenomenon may be produced at the instant the pull force is released, permitting the leaves turn reversely and impossible to completely hide, to harassment to a user.

### SUMMARY OF THE INVENTION

The objective of the invention is to offer a zero-adjuster for lateral leaves of a blind including a housing provided inside with a transmission gear, a worm and an actuating wheel with a square shaft to adjust ropes connected to the leaves of a blind. The transmission gear is engaged with the worm, and the worm has an end engage portion received in the shaft hole of the actuating wheel. Thus, when the rope on the actuating wheel is pulled downward, the actuating wheel together with the worm will rotate to drive the transmission gear and the square shaft to rotate biasly and synchronously activate the ropes on the square shaft to adjust the angles of the leaves. In addition, the end engage portion of the worm has an interior hollow defined by plural position plates arranged in a hexagon shape, with every two position plates spaced apart by a gap so as to let each position plate have proper elasticity. Further, a spring is provided between a pair of the position plates in order to maintain a definite elasticity. Thus, when the angles of the leaves are adjusted to an utmost limit and the transmission gear as well as the worm cannot rotate any longer, in case the rope is continually pulled downward to activate the actuating wheel to rotate, the shaft hole of the actuating wheel will force the engage plates of the worm to deform and shrink inward to let the actuating wheel rotate idle around the worm, thus preventing the worm from damaged.

### BRIEF DESCRIPTION OF THE DRAWINGS

This invention will be better understood by referring to the accompanying drawings, wherein:

FIG. 1 is an exploded perspective view of a zero-adjuster for lateral leaves of a blind of the present invention.

FIG. 2 is a front cross-sectional view of the zero-adjuster for lateral leaves of a blind of the present invention.

FIG. 3 is a side cross-sectional view of the zero-adjuster for lateral leaves of a blind of the present invention.

FIG. 4 is a side view of a worm rod of the present invention.

FIG. 5 is a side cross-sectional view of the zero-adjuster for lateral leaves of a blind in using condition of the present invention.

FIG. 6 is a side view of the worm in using condition of the present invention.

FIG. 7 is an exploded perspective view of a conventional zero-adjuster for lateral leaves of a blind.

FIG. 8 is a side view of the conventional zero-adjuster for lateral leaves of a blind.

### DETAILED DESCRIPTION OF THE PREFERRED EMBODIMENT

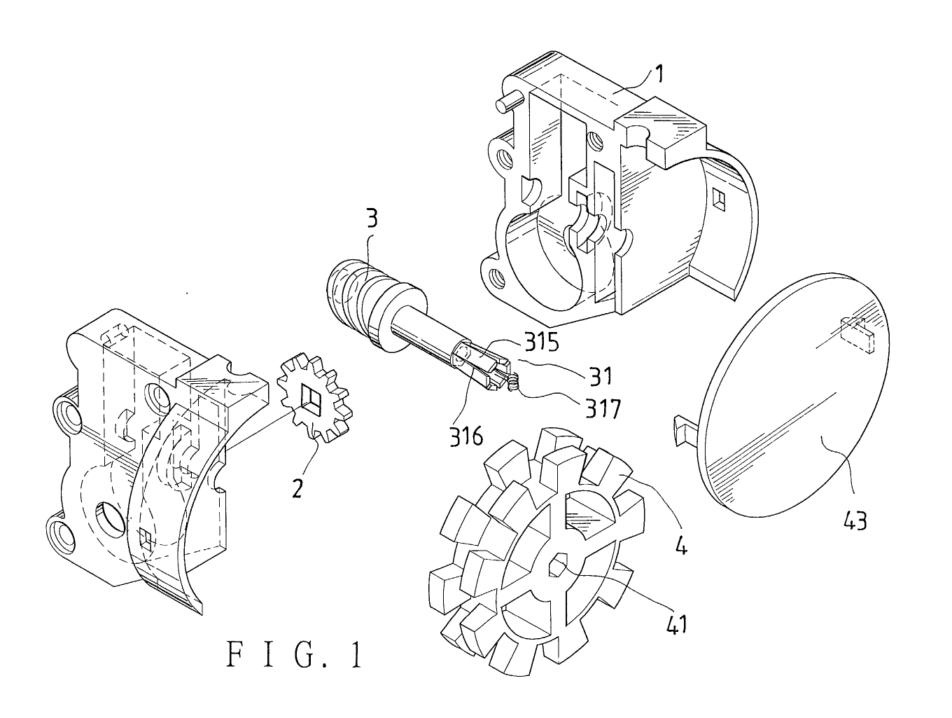

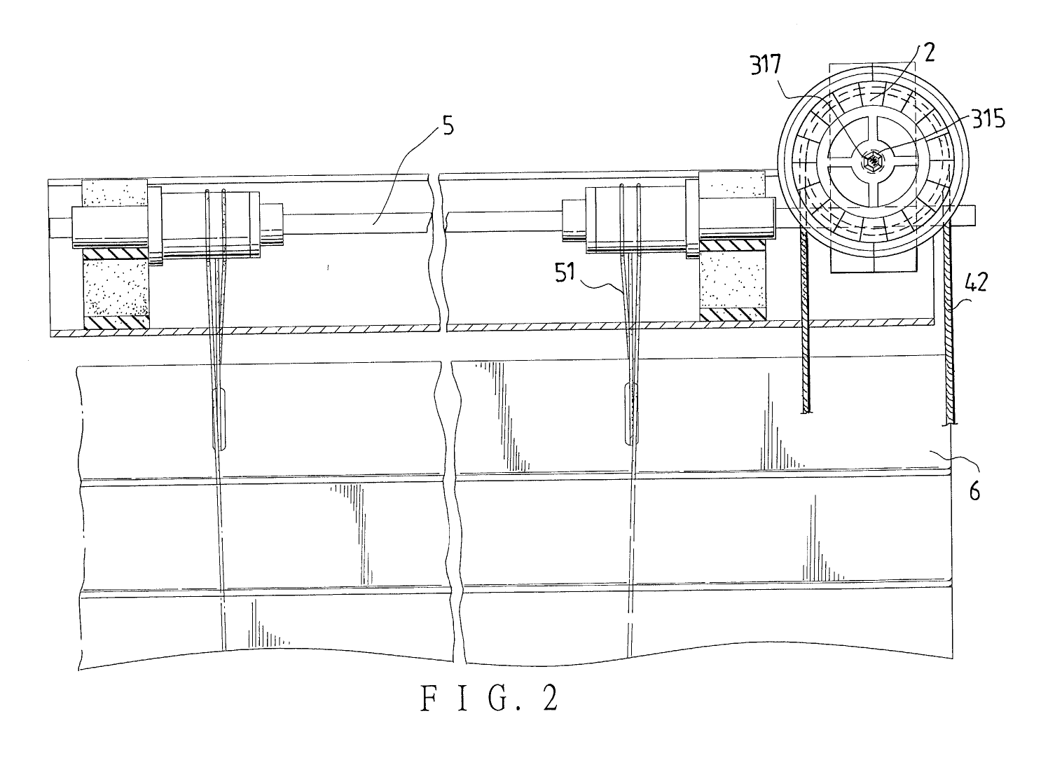

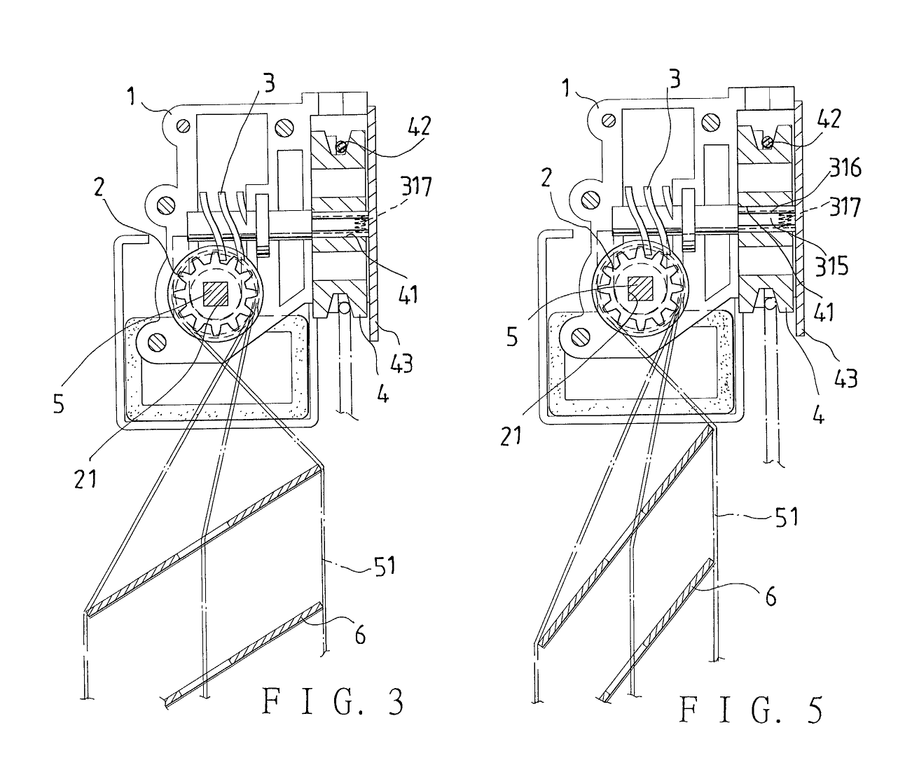

A preferred embodiment of a zero-adjuster for lateral leaves of a blind, referring to FIGS. 1, 2 and 3, includes a housing 1, a transmitting gear 2, a worm 3 and an actuating wheel 4 with a square shaft 5 as main components combined together.

The housing 1 formed with two half members receives the transmitting gear 2, the worm 3 and the actuating wheel 4.

The transmitting gear 2 has a square hole for receiving the square shaft 5.

The worm 3 has an interior hollow engage portion 31 defined by plural position plates 315 arranged in a polygon shape (preferably shaped in hexagon), and every two abutting engage plates 315 are spaced by a gap 316 so as to let respective engage plate 315 have proper elasticity to insert smoothly into the shaft hole 41 of the actuating wheel 4. Further, a spring 317 is provided between a pair of the position plates 315 to let this pair of the position plates 315 capable to keep a pushing-out force and maintain its elasticity.

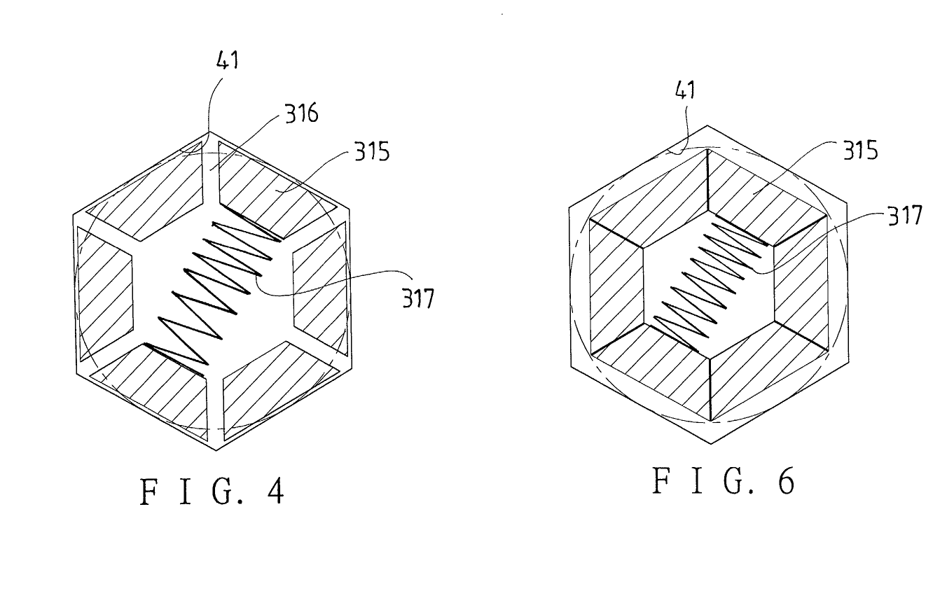

The actuating wheel 4 has a plurality of radial walls spaced apart equidistantly around its outer circumferential edge, and has an annular groove defined between two parallel radial walls for a rope to lie thereon, and further has a hexagon-shaped shaft hole 41 in the center for receiving the same-shaped engage portion 31 of the worm rod 3, as shown in FIG. 4. Then a cover 43 is also provided for covering up the outside of the actuating wheel 4 to prevent the spring 317 from falling off.

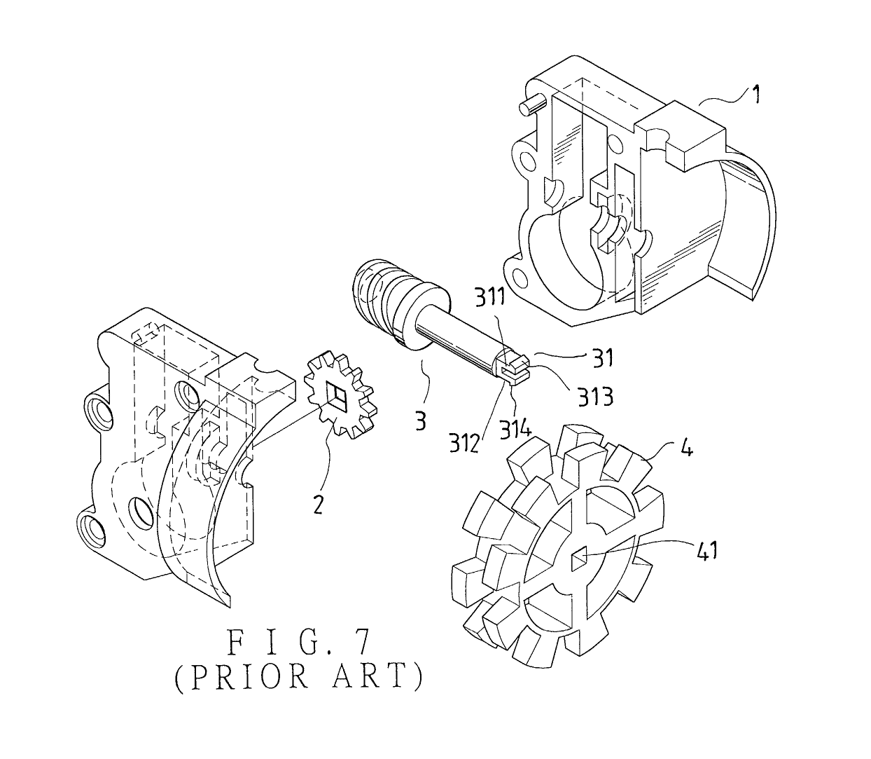

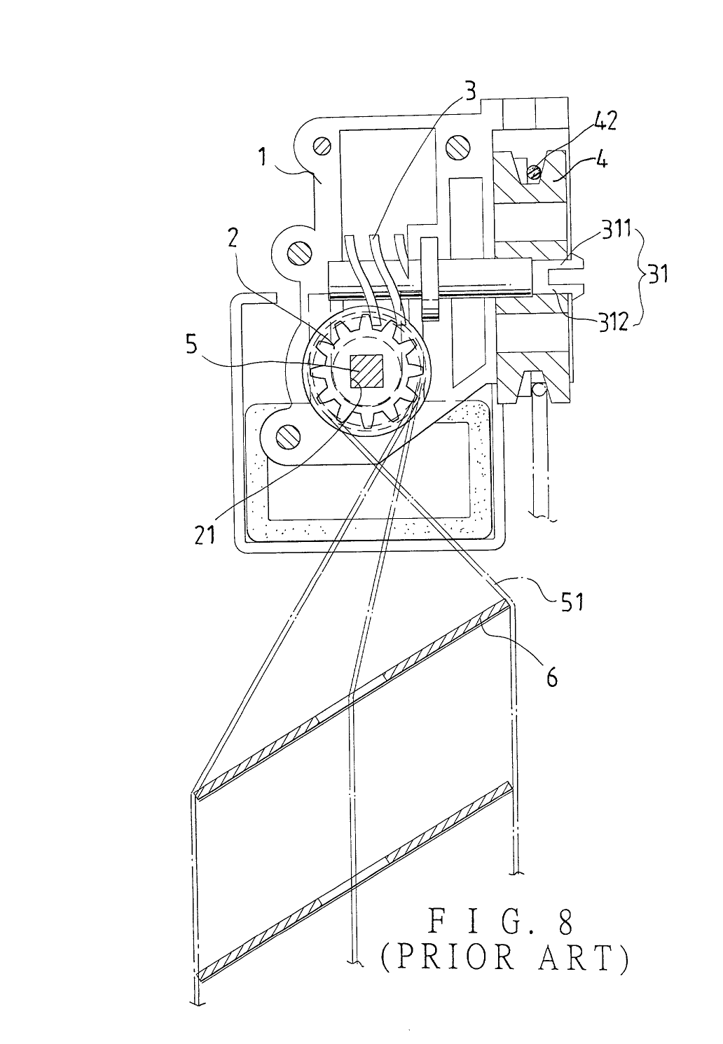

In using, the rope 42 wound around the actuating wheel 4 is pulled downward to activate the actuating wheel 4 together with the worm 3 to rotate and synchronously drive the transmitting gear 2 as well as the square shaft S to rotate biasly and in the mean while the adjusting ropes on the square shaft 5 is also actuated to adjust the angles of the leaves of a blind, as shown in FIG. 5. Furthermore, when the angles of the leaves are adjusted to an utmost limit and the transmitting gear 2 and the worm 3 cannot rotate any more, in case the rope 42 keeps on pulled downward, the engage plates 315 of the engage portion 31 of the worm 3 will be driven to deform and shrink inward by the shaft hole 41 of the actuating wheel 4, as shown in FIG. 6; thus the diameter of the rod body of the engage portion 31 becomes smaller then that of the shaft hole 41, letting the actuating wheel 41 rotate idle around the engage portion 31.

As can be noted from the above description, this invention has the following advantages.

1. The engage portion of the worm is an interior hollow body composed of plural engage plates arranged in a hexagon shape and has a gap between every two abutting engage plates, capable to deform and shrink inward. Thus, when the rope is wrongly or over pulled downward, the actuating wheel will rotate idle around the engage portion of the worm, preventing the engage portion from damaged and prolonging its service life.

2. The elastic force of a spring which is positioned between the pair of the position plates is optional to adjust the engaging force of the engage portion of the worm and the shaft hole of the actuating wheel and also to conform to the size of a blind, possible to obtain a most proper engaging force between the worm and the actuating wheel.

3. When the actuating wheel can no longer pull the rope down, reaching the maximum point in adjusting the leaves, it rotates idly on an upper engaging portion of the worm. Therefore, counter bouncing phenomenon may never happen in case of the rope released, not causing the leaves swing reversely to let the leaves kept in the angle of hiding completely so that the angle-adjusting of the leaves may be ensured.

What is claimed is:

1. A zero-adjuster for lateral leaves of a blind, comprising a housing provided inside with a transmitting gear, a worm and an actuating wheel with a square shaft, said square shaft having adjusting ropes connected to the leaves of a blind, said transmitting gear engaged with said worm, said worm having an end engage portion inserted in the shaft hole of said actuating wheel, said ropes wound around said actuating wheel and pulled downward to activate said actuating wheel to rotate together with said worm and at the same time driving said transmitting gear and said square shaft to rotate biasly and activate said adjusting ropes on said square shaft to adjust the angles of said leaves;
characterized by said worm having an interior hollow engage portion defined by a plurality of position plates arranged in a hexagon shape, every two abutting ones of said position plates spaced apart by a gap to let each said engage plate have proper elasticity and let said engage portion of said worm inserted smoothly in said shaft hole of said actuating wheel, both said shaft hole of said actuating wheel and said engage portion of said worm rod shaped in a same hexagon, a spring provided between a pair of said position plates to let said pair of said position plates maintain a proper outward elasticity, said actuating wheel rotating idle around said worm to prevent said worm from damaged when the angles of said leaves are adjusted to an utmost limit and said transmitting gear and said worm unable to rotate any longer in case said ropes continually pulled downward to activate said actuating wheel to keep on rotating and said shaft hole forcing said engage plates of said worm to deform and shrink inward.

2. The zero-adjuster for lateral leaves of a blind as claimed in claim 1, wherein said engage portion of said worm rod, having interior hollow and defined by said position plates, has the same hexagon shape as said shaft hole of said actuating wheel.

3. The zero-adjuster for lateral leaves of a blind as claimed in claim 1 or 2, wherein said actuating wheel has a cover to cover up its outside in order to prevent said spring from falling off.
